(19) United States
(12) Patent Application Publication
(10) Pub. No.: US 2026/0269728 A1
(43) Pub. Date: Sep. 10, 2026

(54) POWER SUPPLY CIRCUIT

(71) Applicant: ASUSTeK COMPUTER INC., Taipei City (TW)

(72) Inventors: Bo-Siang Cheng, Taipei City (TW); Hsiang-Jui Hung, Taipei City (TW); Sheng-Chieh Su, Taipei City (TW); Min-Hou Kuo, Taipei City (TW); Jia-Ching Huang, Taipei City (TW)

(73) Assignee: ASUSTeK COMPUTER INC., Taipei City (TW)

(21) Appl. No.: 19/550,329

(22) Filed: Feb. 26, 2026

(30) Foreign Application Priority Data
Mar. 5, 2025 (TW) 114108211

(51) Int. Cl. H02M 3/158; H02J 7/90

(52) U.S. Cl. CPC H02M 3/1582; H02J 7/90

(57) ABSTRACT

A power supply circuit is adapted to an electronic device. The power supply circuit comprises a first power interface terminal, a system power terminal, a first switch circuit, a first sense resistor, a second power interface terminal, a buck-boost circuit, a second switch circuit, a battery interface terminal, a second sense resistor, and a third switch circuit. The first sense resistor is connected in series with the first switch circuit between the first power interface terminal and the system power terminal. The buck-boost circuit is coupled between the second power interface terminal and a first node. The second switch circuit is coupled between the first node and a second node. The second sense resistor is coupled between the second node and the battery interface terminal. The third switch circuit is coupled between the system power terminal and the first node.

### CROSS-REFERENCE TO RELATED APPLICATION

This application claims the priority benefit of Taiwan application serial no. 114108211, filed on Mar. 5, 2025. The entirety of the above-mentioned patent application is hereby incorporated by reference herein and made a part of this specification.

### BACKGROUND

### Technical Field

The disclosure relates to a power supply circuit capable of accurately controlling a battery.

### Description of Related Art

Conventionally, when a hybrid charger architecture is connected in parallel with a narrow voltage direct current (NVDC) charger architecture, an inherent circulating current issue may occur. As a result, the voltage across the sense resistor at the NVDC charger terminal is affected, causing distortion in the fed-back current parameter value. The battery charging energy is thus prevented from being accurately controlled, the battery charging current cannot be accurately controlled, more time is needed to fully charge the battery, and user experience is thereby affected.

### SUMMARY

The disclosure provides a power supply circuit adapted to an electronic device. The power supply circuit comprises a first power interface terminal, a system power terminal, a first switch circuit, a first sense resistor, a second power interface terminal, a buck-boost circuit, a second switch circuit, a battery interface terminal, a second sense resistor, and a third switch circuit. The first power interface terminal is configured to receive a first power voltage. The first switch circuit is coupled between the first power interface terminal and the system power terminal. The first sense resistor is connected in series with the first switch circuit between the first power interface terminal and the system power terminal. The second power interface terminal is configured to receive a second power voltage. The buck-boost circuit is coupled between the second power interface terminal and a first node. The second switch circuit is coupled between the first node and a second node. The battery interface terminal is configured to receive a battery voltage. The second sense resistor is coupled between the second node and the battery interface terminal. The third switch circuit is coupled between the system power terminal and the first node.

To sum up, through the power supply circuit provided by the disclosure, the inherent circulating current issue is solved. In this way, the battery is accurately controlled, excessive battery charging duration is avoided, and improved user experience is provided.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram illustrating a power supply circuit according to an embodiment of the disclosure.

FIG. 2 is a schematic circuit diagram illustrating the power supply circuit according to an embodiment of the disclosure.

FIG. 3A to FIG. 3F are schematic diagrams illustrating operations the power supply circuit according to an embodiment of the disclosure.

### DESCRIPTION OF THE EMBODIMENTS

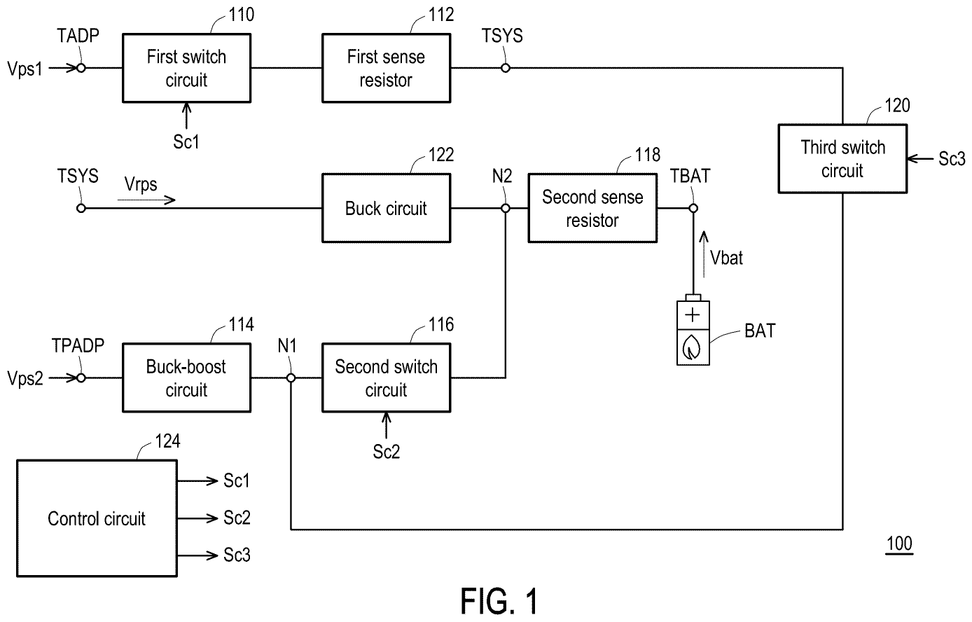

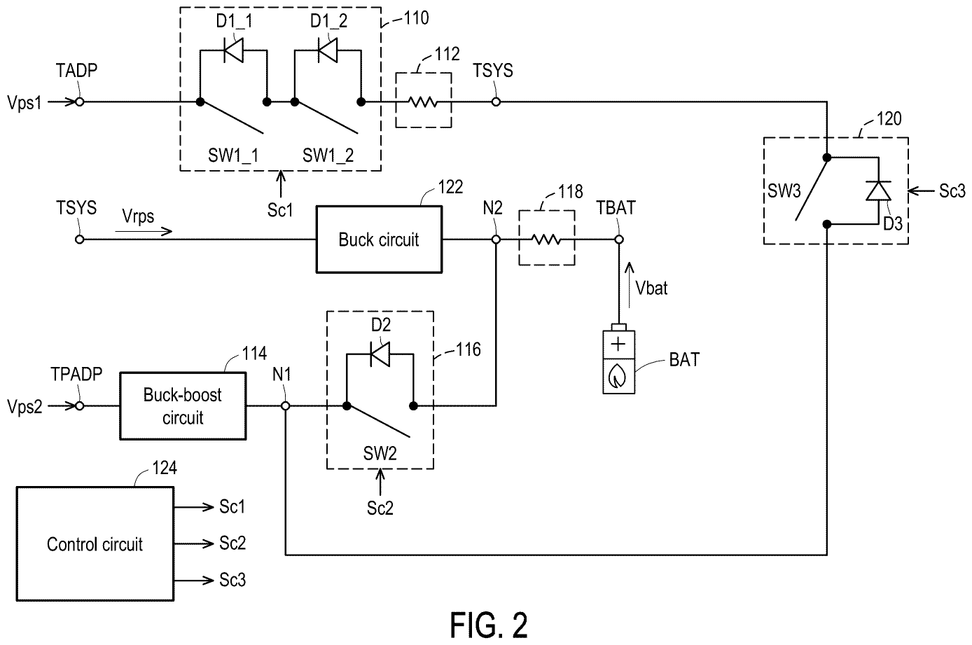

With reference to FIG. 1 and FIG. 2 together, a power supply circuit 100 is adapted to an electronic device such as a notebook computer, a mobile phone, a tablet computer, and other handheld electronic products. In one embodiment, the power supply circuit 100 is considered as a circuit architecture formed by paralleling a hybrid charger architecture with a narrow voltage direct current (NVDC) charger architecture and comprises a first power interface terminal TADP, a system power terminal TSYS, a first switch circuit 110, a first sense resistor 112, a second power interface terminal TPADP, a buck-boost circuit 114, a second switch circuit 116, a battery interface terminal TBAT, a second sense resistor 118, a third switch circuit 120, a buck circuit 122, and a control circuit 124.

In one embodiment, the first power interface terminal TADP is plugged into a first power adapter, such as an alternating current adapter. The first power interface terminal TADP is used to receive a first power voltage Vps1 (for example, 20 volts) from the first power adapter.

In one embodiment, the system power terminal TSYS is used to transmit the received power voltage to a central processing unit (CPU), a graphics processing unit (GPU), or other various system components on a motherboard via a voltage regulator, for example, and to transmit a remaining power voltage Vrps not used by a system to the buck circuit 122.

The first switch circuit 110 is coupled between the first power interface terminal TADP and the system power terminal TSYS. The first sense resistor 112 is connected in series with the first switch circuit 110 between the first power interface terminal TADP and the system power terminal TSYS. As shown in FIG. 2, the first switch circuit 110 comprises two first switches SW1_1 and SW1_2 connected in series and two first diodes D1_1 and D1_2 connected in parallel with the first switches SW1_1 and SW1_2 respectively. Anodes of the two first diodes D1_1 and D1_2 are coupled to each other, a cathode of the first diode D1_1 is coupled to the first power interface terminal TADP, and a cathode of the first diode D1_2 is coupled to the first sense resistor 112. In one embodiment, a voltage across the first sense resistor 112 is used by part of a hybrid charger chip in the control circuit 124 to detect a current parameter value flowing through the first sense resistor 112.

In one embodiment, the second power interface terminal TPADP is plugged into a second power adapter, such as a PD adapter (providing power in USB Type-C PD manner). The second power interface terminal TPADP is used to receive a second power voltage Vps2 (for example, 5 volts to 20 volts) from the second power adapter.

The buck-boost circuit 114 is coupled between the second power interface terminal TPADP and a first node N1. In this embodiment, the buck-boost circuit 114 may operate depending on whether the second power voltage Vps2 is provided to the second power interface terminal TPADP. For instance, when the second power voltage Vps2 is provided to the second power interface terminal TPADP, the buck-boost circuit 114 is turned on and boosts or bucks the received second power voltage Vps2 and outputs it. When the second power voltage Vps2 is not provided to the second power interface terminal TPADP, the buck-boost circuit 114 is turned off.

The second switch circuit 116 is coupled between the first node N1 and a second node N2. As shown in FIG. 2, the second switch circuit 116 comprises a second switch SW2 and a second diode D2 connected in parallel with the second switch SW2. An anode of the second diode D2 is coupled to the second node N2, and a cathode of the second diode D2 is coupled to the first node N1.

When a battery BAT is installed in the electronic device, the battery interface terminal TBAT is coupled to the battery BAT and is used to receive a battery voltage Vbat (for example, 12 volts to 16 volts) from the battery BAT.

The second sense resistor 118 is coupled between the second node N2 and the battery interface terminal TBAT. In one embodiment, a voltage across the second sense resistor 118 is used by part of a NVDC charger chip in the control circuit 124 to detect a current parameter value (equivalent to a charging current of the battery BAT) flowing through the second sense resistor 118. Incidentally, in this embodiment, only one sense resistor is used for the NVDC charger chip, and optimization of reducing the total number of parts can be achieved.

The third switch circuit 120 is coupled between the system power terminal TSYS and the first node N1. As shown in FIG. 2, the third switch circuit 120 comprises a third switch SW3 and a third diode D3 connected in parallel with the third switch SW3. An anode of the third diode D3 is coupled to the first node N1, and a cathode of the third diode D3 is coupled to the system power terminal TSYS.

The buck circuit 122 is coupled between the system power terminal TSYS and the second node N2. In this embodiment, the buck circuit 122 may operate depending on whether the battery BAT providing the battery voltage Vbat to the battery interface terminal TBAT is required to be charged. For instance, when the battery BAT is required to be charged, the buck circuit 122 is turned on and bucks the received power voltage Vrps and output it. When the battery BAT is not required to be charged, the buck circuit 122 is turned off.

In one embodiment, the control circuit 124 may be implemented with a plurality of independent charger chips (including the hybrid charger chip and the NVDC charger chip) and a logic circuit designed by a person having ordinary skill in the art, using information from sources such as an embedded controller (EC), a battery gauge IC, and system. In one embodiment, the control circuit 124 provides a first control signal Sc1, a second control signal Sc2, and a third control signal Sc3 to the first switch circuit 110, the second switch circuit 116, and the third switch circuit 120 respectively according to a power connection state of each of the first power interface terminal TADP, the second power interface terminal TPADP, and the battery interface terminal TBAT, so as to turn on or turn off (disconnecting) the first switches SW1_1 and SW1_2 in the first switch circuit 110, the second switch SW2 in the second switch circuit 116, and the third switch SW3 in the third switch circuit 120.

It shall be noted that in the power supply circuit 100 of this embodiment, there is no connection through any switch between the system power terminal TSYS and the second node N2. Therefore, compared with the circuit architectures of the related art, the inherent circulating current issue may be solved.

The following examples illustrate the operational details of the power supply circuit 100. Table 1 lists 8 operation configurations of the power supply circuit 100. In Table 1, the first power interface terminal TADP and the second power interface terminal TPADP being “0” represents no voltage input, while the first power interface terminal TADP and the second power interface terminal TPADP being “1” represents voltage (Vps1 or Vps2) input. The battery interface terminal TBAT being “0” represents no voltage input from the battery BAT (equivalent to no voltage output to the system, including situations where the battery BAT is in a dead battery state or the battery BAT is removed), while the battery interface terminal TBAT being “1” represents voltage (Vbat) input from the battery BAT (equivalent to voltage output to the system). The first switch circuit 110, the second switch circuit 116, and the third switch circuit 120 being “ON” represents that the switches (SW1_1, SW1_2, SW2, or SW3) in the switch circuits are turned on, while the first switch circuit 110, the second switch circuit 116, and the third switch circuit 120 being “OFF” represents that the switches (SW1_1, SW1_2, SW2, or SW3) in the switch circuits are turned off.

TABLE 1

| Operation | | | | | | |
|---|---|---|---|---|---|---|
| configuration | TADP | TPADP | TBAT | 110 | 116 | 120 |
| 1 | 0 | 0 | 0 | OFF | OFF | OFF |
| 2 | 0 | 0 | 1 | OFF | ON | ON |
| 3 | 0 | 1 | 0 | OFF | ON: battery activated | ON |
| | | | | | OFF: battery not activated | |
| 4 | 0 | 1 | 1 | OFF | ON: charging required | ON |
| | | | | | OFF: charging not required | |
| 4 | 1 | 0 | 0 | ON | ON: battery activated | OFF |
| | | | | | OFF: battery not activated | |
| 6 | 1 | 0 | 1 | ON | ON | OFF |
| 7 | 1 | 1 | 0 | ON | ON: battery activated | OFF |
| | | | | | OFF: battery not activated | |
| 8 | 1 | 1 | 1 | ON | OFF | OFF |

When no voltage is provided to the first power interface terminal TADP, the second power interface terminal TPADP, and the battery interface terminal TBAT (i.e., operation configuration 1, TADP/TPADP/TBAT=0/0/0), the first switches SW1_1 and SW1_2 in the first switch circuit 110, the second switch SW2 in the second switch circuit 116, and the third switch SW3 in the third switch circuit 120 are turned off. In this case, no switches are turned on and the system has no power.

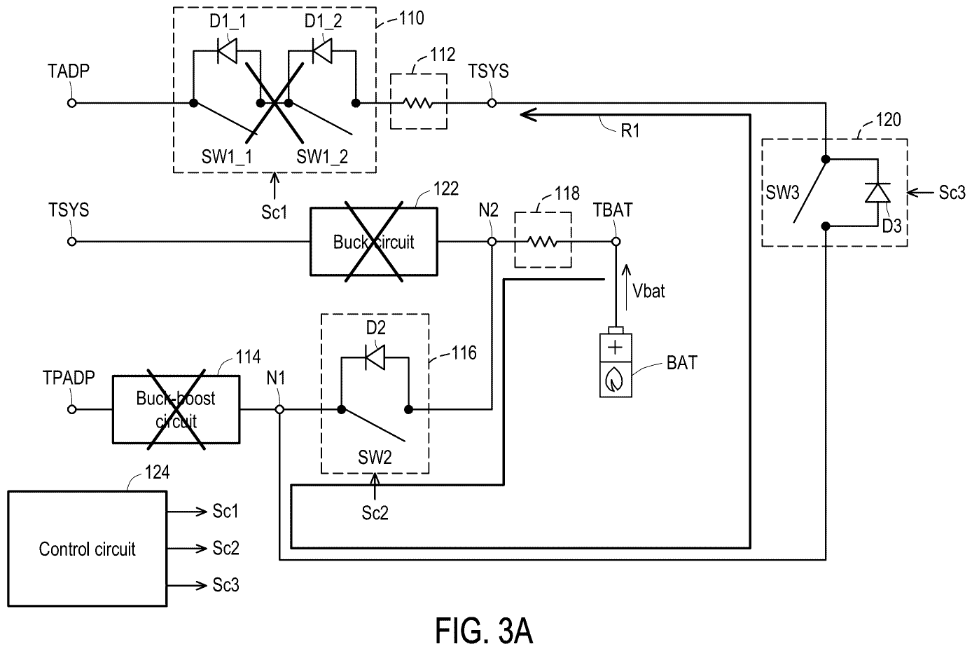

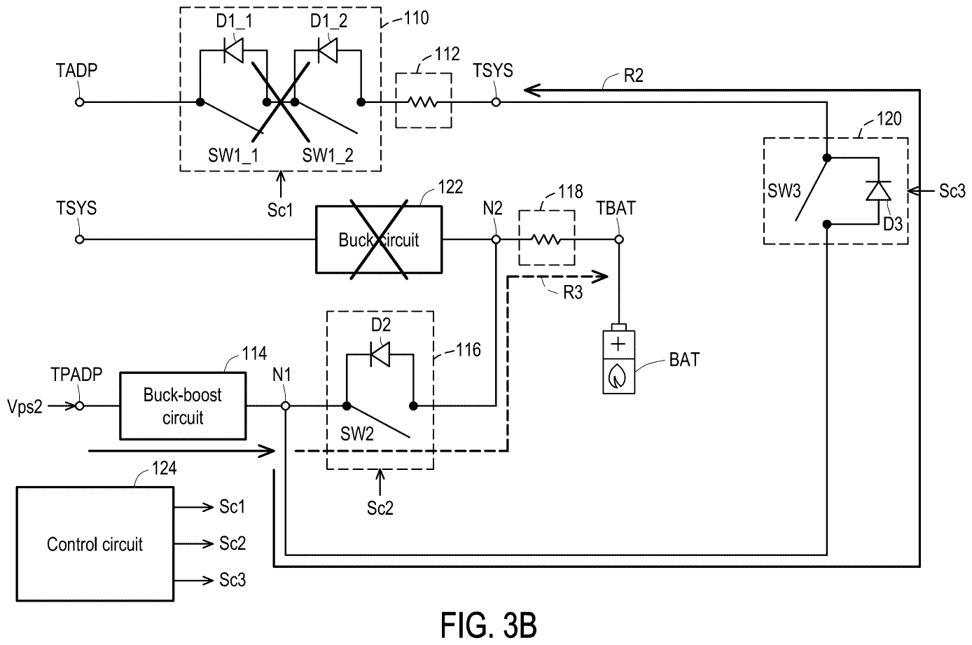

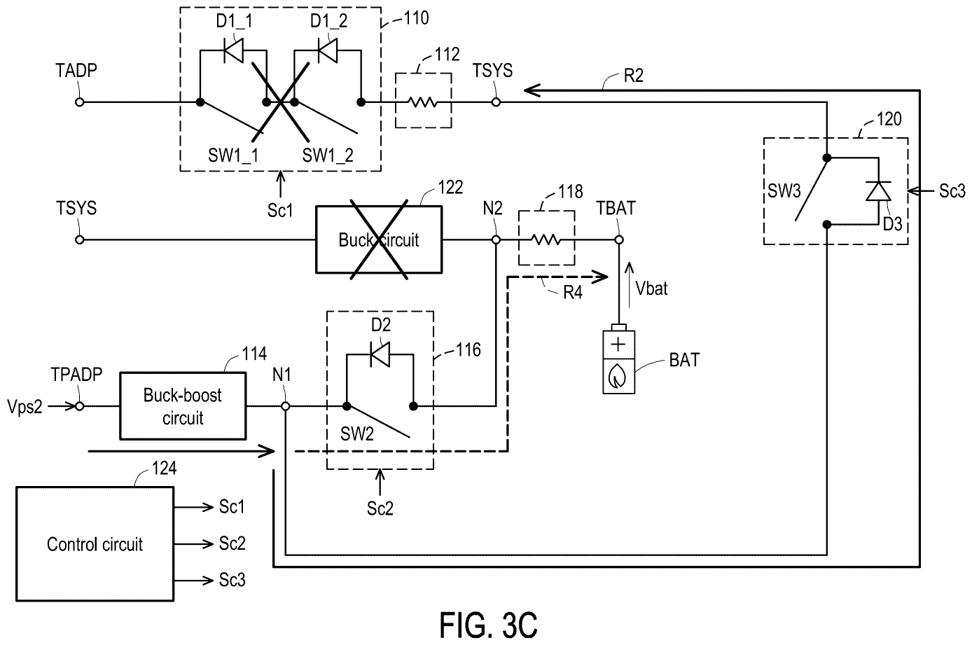

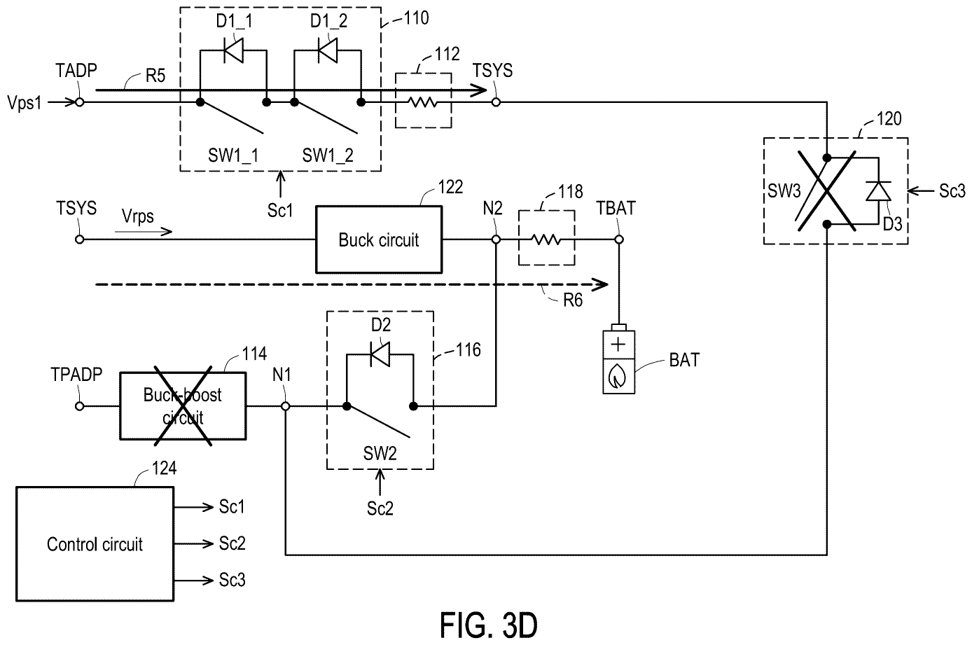

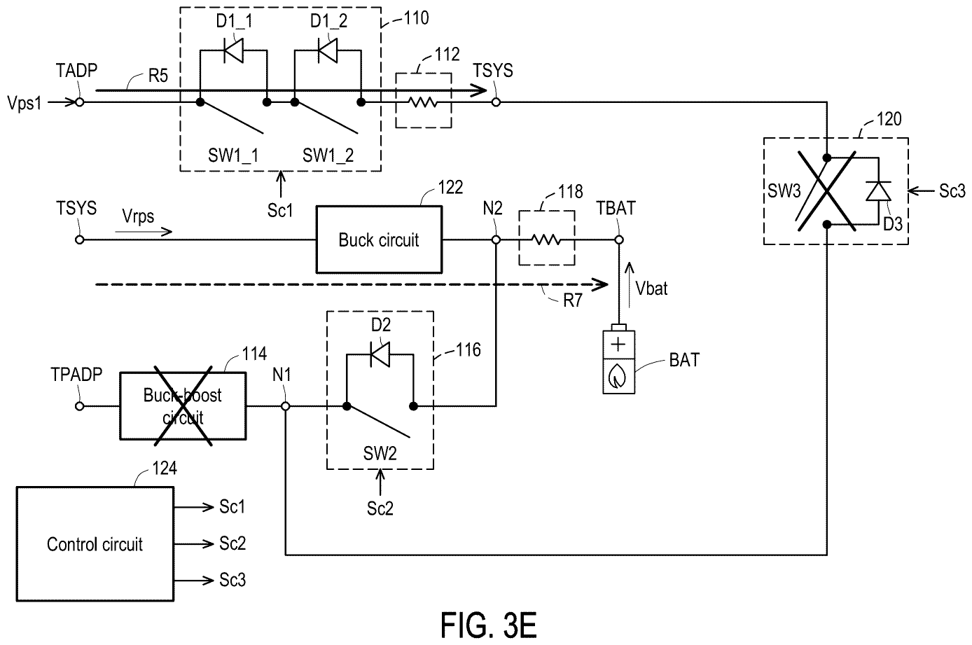

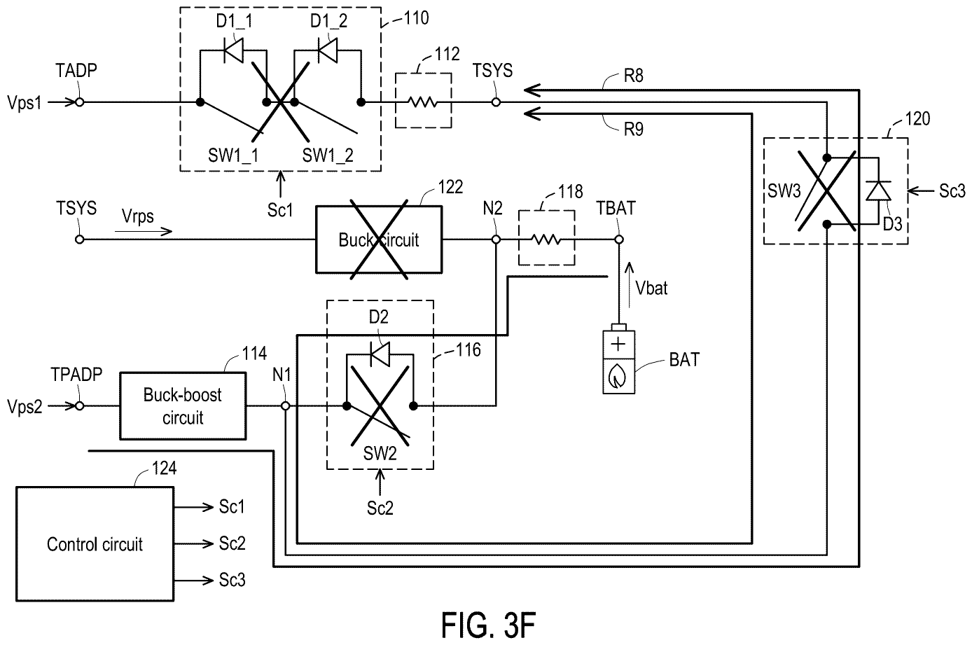

When no voltage is provided to the first power interface terminal TADP and the second power interface terminal TPADP and the battery voltage Vbat is provided to the battery interface terminal TBAT (i.e., operation configuration 2, TADP/TPADP/TBAT=0/0/1), the first switches SW1_1 and SW1_2 in the first switch circuit 110 are turned off, while the second switch SW2 in the second switch circuit 116 and the third switch SW3 in the third switch circuit 120 are turned on. To be specific, as shown in FIG. 3A, in this case, only the battery voltage Vbat is provided to the battery interface terminal TBAT and the part of the hybrid charger chip in the control circuit 124 recognizes that it is in a direct current mode (DC mode), so the first switches SW1_1 and SW1_2 in the first switch circuit 110 are turned off, and that the buck circuit 122 is not in operation (turned off). The part of the NVDC charger chip in the control circuit 124 also recognizes that it is in the DC mode, so the second switch SW2 in the second switch circuit 116 is turned on, and that the buck-boost circuit 114 is not in operation. The third switch SW3 in the third switch circuit 120 is turned on due to no voltage being provided to the first power interface terminal TADP. In this case, energy at the system power terminal TSYS is supplied by the battery BAT. As shown by a path R1, the energy is transmitted to the system power terminal TSYS via the battery interface terminal TBAT, the second switch circuit 116, and the third switch circuit 120.

When no voltage is provided to the first power interface terminal TADP and the battery interface terminal TBAT and the second power voltage Vps2 is provided to the second power interface terminal TPADP (i.e., operation configuration 3, TADP/TPADP/TBAT=0/1/0), the first switches SW1_1 and SW1_2 in the first switch circuit 110 are turned off, and the third switch SW3 in the third switch circuit 120 is turned on. The second switch SW2 in the second switch circuit 116 is continuously switched between on and off within a predetermined time period. To be specific, as shown in FIG. 3B, in this case, only the second power voltage Vps2 is provided to the second power interface terminal TPADP and the part of the hybrid charger chip in the control circuit 124 recognizes that it is in the DC mode, so the first switches SW1_1 and SW1_2 in the first switch circuit 110 are turned off, and that the buck circuit 122 is not in operation. The part of the NVDC charger chip in the control circuit 124 recognizes that it is in an alternating current mode (AC Mode) and no voltage is input from the battery BAT, so the NVDC charger chip enters a trickle charging mode, and the second switch SW2 in the second switch circuit 116 is continuously switched between on and off, so as to attempt to charge the battery BAT with a low current to exit the dead battery state. When the battery voltage Vbat begins to be provided to the battery interface terminal TBAT within the predetermined time period, the second switch SW2 in the second switch circuit 116 is turned on. When the battery voltage Vbat is still not provided to the battery interface terminal TBAT after the predetermined time period has passed, the second switch SW2 in the second switch circuit 116 remains turned off. That is, the switching state of the second switch circuit 116 depends on whether the battery BAT can be activated by charging energy.

The third switch SW3 in the third switch circuit 120 is turned on due to no voltage being provided to the first power interface terminal TADP. In this case, the energy at the system power terminal TSYS is provided by the second power voltage Vps2. As shown by a path R2, the energy is transmitted to the system power terminal TSYS via the second power interface terminal TPADP and the third switch circuit 120. In addition, a path R3 represents an energy path attempting to activate the battery BAT.

When no voltage is provided to the first power interface terminal TADP, the second power voltage Vps2 is provided to the second power interface terminal TPADP, and the battery voltage Vbat is provided to the battery interface terminal TBAT (i.e., operation configuration 4, TADP/TPADP/TBAT=0/1/1), the first switches SW1_1 and SW1_2 in the first switch circuit 110 are turned off, the third switch SW3 in the third switch circuit 120 is turned on, and the second switch SW2 in the second switch circuit 116 is turned on or turned off depending on whether the battery BAT providing the battery voltage Vbat to the battery interface terminal TBAT is required to be charged. To be specific, as shown in FIG. 3C, in this case, the second power voltage Vps2 is provided to the second power interface terminal TPADP, the battery voltage Vbat is provided to the battery interface terminal TBAT as well, and the part of the hybrid charger chip in the control circuit 124 recognizes that it is in the DC mode, so the first switches SW1_1 and SW1_2 in the first switch circuit 110 are turned off, and that the buck circuit 122 is not in operation. The part of the NVDC charger chip in the control circuit 124 recognizes that it is in the AC mode and the battery voltage Vbat is normally input from the battery BAT, so the second switch circuit 116 is controlled according to whether the battery BAT is required to be charged. When charging is required, the second switch SW2 in the second switch circuit 116 is turned on, and when charging is not required, the second switch SW2 in the second switch circuit 116 is turned off.

The third switch SW3 in the third switch circuit 120 is turned on due to no voltage being provided to the first power interface terminal TADP. In this case, similar to operation configuration 3, the energy at the system power terminal TSYS is provided by the second power voltage Vps2. As shown by the path R2, the energy is transmitted to the system power terminal TSYS via the second power interface terminal TPADP and the third switch circuit 120. In addition, a path R4 represents an energy path when the battery BAT is required to be charged.

When the first power voltage Vps1 is provided to the first power interface terminal TADP and no voltage is provided to the second power interface terminal TPADP and the battery interface terminal TBAT (i.e., operation configuration 5, TADP/TPADP/TBAT=1/0/0), the first switches SW1_1 and SW1_2 in the first switch circuit 110 are turned on, the third switch SW3 in the third switch circuit 120 is turned off, and the second switch SW2 in the second switch circuit 116 is turned on or turned off depending on whether the battery BAT used to provide the battery voltage Vbat to the battery interface terminal TBAT is activated. To be specific, as shown in FIG. 3D, in this case, only the first power voltage Vps1 is provided to the battery interface terminal TBAT and the part of the hybrid charger chip in the control circuit 124 recognizes that it is in the AC mode, so the first switches SW1_1 and SW1_2 in the first switch circuit 110 are turned on. Further, no voltage is input from the battery BAT, and that the buck circuit 122 is in operation, and the hybrid charger chip enters the trickle charging mode to attempt to charge with a low current to bring the battery BAT out of the dead battery state, until the predetermined time period has passed.

When the battery voltage Vbat begins to be provided to the battery interface terminal TBAT within the predetermined time period, the part of the NVDC charger chip in the control circuit 124 recognizes that it is in the DC mode, so the second switch SW2 in the second switch circuit 116 is turned on (but its current path is not established), and that the buck-boost circuit 114 is not in operation. When there is still no battery voltage Vbat provided to the battery interface terminal TBAT after the predetermined time period, the part of the NVDC charger chip in the control circuit 124 recognizes that there is no power, so the second switch SW12 in the second switch circuit 116 is turned off, and that the buck-boost circuit 114 is not in operation.

The third switch SW3 in the third switch circuit 120 is turned off due to the first power voltage Vps1 being provided to the first power interface terminal TADP. In this case, the energy at the system power terminal TSYS is provided by the first power voltage Vps1. As shown by a path R5, the energy is transmitted to the system power terminal TSYS via the first power interface terminal TADP and the first switch circuit 110. In addition, a path R6 represents an energy path attempting to activate the battery BAT.

When the first power voltage Vps1 is provided to the first power interface terminal TADP, the battery voltage Vbat is provided to the battery interface terminal TBAT, and without voltage provided to the second power interface terminal TPADP (i.e., operation configuration 6, TADP/TPADP/TBAT=1/0/1), the first switches SW1_1 and SW1_2 in the first switch circuit 110, the second switch SW2 in the second switch circuit 116, and the third switch SW3 in the third switch circuit 120 are turned off. To be specific, as shown in FIG. 3E, in this case, the first power voltage Vps1 is provided to the first power interface terminal TADP, the battery voltage Vbat is provided to the battery interface terminal TBAT as well, and the part of the hybrid charger chip in the control circuit 124 recognizes that it is in the AC mode, so the first switches SW1_1 and SW1_2 in the first switch circuit 110 are turned on and the battery voltage Vbat is normally input from the battery BAT, and that the buck circuit 122 operates depending on whether the battery BAT providing the battery voltage Vbat to the battery interface terminal TBAT is required to be charged. When the battery BAT is required to be charged, the buck circuit 122 is turned on and bucks the received power voltage Vrps from the system power terminal TSYS and output it. When the battery BAT is not required to be charged, the buck circuit 122 is turned off.

The third switch SW3 in the third switch circuit 120 is turned off due to the first power voltage Vps1 being provided to the first power interface terminal TADP. In this case, similar to operation configuration 5, the energy at the system power terminal TSYS is provided by the first power voltage Vps1. As shown by the path R5, the energy is transmitted to the system power terminal TSYS via the first power interface terminal TADP and the first switch circuit 110. In addition, a path R7 represents an energy path when the battery BAT is required to be charged.

When the first power voltage Vps1 is provided to the first power interface terminal TADP and the second power voltage Vps2 is provided to the second power interface terminal TPADP (i.e., operation configurations 7 and 8, TADP/TPADP/TBAT=1/1/0 and 1/1/1), regardless of whether the battery voltage Vbat is provided to the battery interface terminal TBAT, the second power voltage Vps2 is removed from the second power interface terminal TPADP through circuit design. Therefore, the operation details of operation configuration 7 are the same as those of operation configuration 5, and the operation details of operation configuration 8 are the same as those of operation configuration 6, so description thereof is not repeated herein.

In addition, the above 8 operation configurations are for the steady-state part, but the transient part requires special attention to the timing of control authority alternation. Since the control weight of the first power voltage Vps1 is greater than that of the second power voltage Vps2 and the battery voltage Vbat, regardless of the original system state, as long as the first power adapter providing the first power voltage Vps1 is plugged into the first power interface terminal TADP, a transfer of control authority occurs. At this time, it is necessary to ensure that the third switch SW3 in the third switch circuit 120 must be turned off before the first switches SW1_1 and SW1_2 in the first switch circuit 110 are turned on, otherwise a voltage conflict (short circuit) issue may occur.

For instance, in the situation where the second power voltage Vps2 is provided to the second power interface terminal TPADP, the energy at the system power terminal TSYS is provided by the second power voltage Vps2. As shown in FIG. 3F, the energy is transmitted to the system power terminal TSYS via the second power interface terminal TPADP and the third switch circuit 120. At this time, When the first power voltage Vps1 is provided to the first power interface terminal TADP, then the third switch SW3 in the third switch circuit 120 is turned off before the first switches SW1_1 and SW1_2 in the first switch circuit 110 are turned on, so as to avoid the conflict between the first power voltage Vps1 and the second power voltage Vps2 at the system power terminal TSYS.

Further, during the brief period when the third switch SW3 in the third switch circuit 120 is turned off but the first switches SW1_1 and SW1_2 in the first switch circuit 110 have not yet turned on, as shown by path a R8, energy is provided to the system power terminal TSYS from the second power voltage Vps2 through the third diode D3 in the third switch circuit 120. After the first switches SW1_1 and SW1_2 in the first switch circuit 110 are turned on, the second power voltage Vps2 is then be removed from the second power interface terminal TPADP.

On the other hand, in the situation where the second power voltage Vps2 is originally provided to the second power interface terminal TPADP and the battery voltage Vbat is provided to the battery interface terminal TBAT, the second power adapter providing the second power voltage Vps2 is suddenly unplugged from the second power interface terminal TPADP. In this case, as shown by a path R9, although the second switch SW2 in the second switch circuit 116 is not turned on that quickly, due to the help of the second diode D2, the battery BAT can immediately supply energy to the system power terminal TSYS.

In view of the above, the inherent circulating current issue may be solved through the power supply circuit provided by the disclosure, and the sense resistors used for NVDC charger chip is reduced to one. In this way, the battery may be accurately controlled, excessive battery charging duration is avoided, and optimization by reducing the total number of components is achieved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power supply circuit adapted to an electronic device, the power supply circuit comprising:
a first power interface terminal configured to receive a first power voltage;
a system power terminal;
a first switch circuit coupled between the first power interface terminal and the system power terminal;
a first sense resistor connected in series with the first switch circuit between the first power interface terminal and the system power terminal;
a second power interface terminal configured to receive a second power voltage;
a buck-boost circuit coupled between the second power interface terminal and a first node;
a second switch circuit coupled between the first node and a second node;
a battery interface terminal configured to receive a battery voltage;
a second sense resistor coupled between the second node and the battery interface terminal; and
a third switch circuit coupled between the system power terminal and the first node.

2. The power supply circuit according to claim 1, further comprising:
a buck circuit coupled between the system power terminal and the second node.

3. The power supply circuit according to claim 1, further comprising:
a control circuit configured to provide a first control signal, a second control signal, and a third control signal to the first switch circuit, the second switch circuit, and the third switch circuit respectively according to a power connection state of each of the first power interface terminal, the second power interface terminal, and the battery interface terminal, so as to turn on or turn off the first switch circuit, the second switch circuit, and the third switch circuit.

4. The power supply circuit according to claim 1, wherein the buck-boost circuit operates depending on whether the second power voltage is provided to the second power interface terminal.

5. The power supply circuit according to claim 1, wherein when no voltage is provided to the first power interface terminal, the second power interface terminal, and the battery interface terminal, the first switch circuit, the second switch circuit, and the third switch circuit are turned off.

6. The power supply circuit according to claim 1, wherein when no voltage is provided to the first power interface terminal and the second power interface terminal and the battery voltage is provided to the battery interface terminal, the first switch circuit is turned off, and the second switch circuit and the third switch circuit are turned on.

7. The power supply circuit according to claim 1, wherein when no voltage is provided to the first power interface terminal and the battery interface terminal and the second power voltage is provided to the second power interface terminal, the first switch circuit is turned off, the third switch circuit is turned on, and the second switch circuit is continuously switched between on and off within a predetermined time period.

8. The power supply circuit according to claim 7, wherein if the battery voltage is still not provided to the battery interface terminal after the predetermined time period, he second switch circuit remains turned off.

9. The power supply circuit according to claim 1, wherein when no voltage is provided to the first power interface terminal, the second power voltage is provided to the second power interface terminal, and the battery voltage is provided to the battery interface terminal, the first switch circuit is turned off, the third switch circuit is turned on, and the second switch circuit is turned on or off depending on whether a battery providing the battery voltage to the battery interface terminal is required to be charged.

10. The power supply circuit according to claim 2, wherein when the first power voltage is provided to the first power interface terminal and no voltage is provided to the second power interface terminal and the battery interface terminal, the first switch circuit is turned on, the third switch circuit is turned off, and the second switch circuit is turned on or off depending on whether a battery used to provide the battery voltage to the battery interface terminal is activated.

11. The power supply circuit according to claim 2, wherein when the first power voltage is provided to the first power interface terminal, the battery voltage is provided to the battery interface terminal, and no voltage is provided to the second power interface terminal, the first switch circuit and the second switch circuit are turned on, and the third switch circuit is turned off.

12. The power supply circuit according to claim 11, wherein the buck circuit operates depending on whether a battery providing the battery voltage to the battery interface terminal is required to be charged.

13. The power supply circuit according to claim 1, wherein when the first power voltage is provided to the first power interface terminal and the second power voltage is provided to the second power interface terminal, the second power voltage is removed from the second power interface terminal.

14. The power supply circuit according to claim 1, wherein when the second power voltage is provided to the second power interface terminal, if the first power voltage is provided to the first power interface terminal, the third switch circuit is turned off before the first switch circuit is turned on.

15. The power supply circuit according to claim 14, wherein after the first switch circuit is turned on, the second power voltage is removed from the second power interface terminal.

16. The power supply circuit according to claim 1, wherein the first switch circuit comprises two first switches connected in series and two first diodes connected in parallel with the two first switches, anodes of the two first diodes are coupled to each other, a cathode of one of the two first diodes is coupled to the first power interface terminal, and a cathode of the other one of the two first diodes is coupled to the first sense resistor.

17. The power supply circuit according to claim 1, wherein the second switch circuit comprises a second switch and a second diode connected in parallel with the second switch, an anode of the second diode is coupled to the second node, and a cathode of the second diode is coupled to the first node.

18. The power supply circuit according to claim 1, wherein the third switch circuit comprises a third switch and a third diode connected in parallel with the third switch, an anode of the third diode is coupled to the first node, and a cathode of the third diode is coupled to the system power terminal.

19. The power supply circuit according to claim 1, wherein the first power interface terminal receives the first power voltage from a first power adapter, the second power interface terminal receives the second power voltage from a second power adapter, and the battery interface terminal receives the battery voltage from a battery.
